(19) United States
(12) Patent Application Publication
(10) Pub. No.: US 2008/0278979 A1
(43) Pub. Date: Nov. 13, 2008

(54) n-Buck cascade converter with single active switch

(76) Inventors: Guadalupe Ortiz-Lopez, Sal Luis Potosi (MX); Jesus Leyva-Ramos, San Luis Potosi (MX); Luis Humberto Diaz-Saldierna, San Luis Potosi (MX)

Correspondence Address: Robert P. Simpson;Simpson & Simpson, PLLC, 5555 Main Street, Williamsville, NY, 14221, US

(21) Appl. No.: 11/801,476

(22) Filed: May 10, 2007

(51) Int. Cl. H02J 1/10

(52) U.S. Cl. 363/65

(57) ABSTRACT

An n-buck cascade converter, where the DC conversion ratio is Uⁿ where U is the duty ratio. The converter comprises n inductors, n capacitors, (2n-1) diodes and a MOSFET transistor. The cascading configuration uses the minimum number of active switches while avoiding complex control circuitry. It is assumed that this converter operates in continuous condition mode, i.e., all the inductor currents never decay to zero. The corresponding formulae for the ripples in the capacitor voltages and the inductor currents are given. This allows designing in principle a specific converter following some specifications.

### BACKGROUND OF THE INVENTION

During the last two decades, a great number of applications for DC-DC converters have been reported. New technological developments require power supplies with significant step-down voltages. A possible solution to this problem is to use n-stages connected in cascade using n-active switches; however, the major drawbacks are: (a) the total losses are increased mainly by the active switches, and (b) a more complex control circuitry is required. An alternative solution is to use an n-buck cascade converter with a single active switch. This converter, in accordance with the present invention, provides a wider conversion rate producing a lower voltage/higher current output.

Switching converters are electronic circuits that allow energy conversion from one DC level to another. These switching converters are widely used in the power supply industry. They operate under the principle of storing energy in an inductor L, from an unregulated power source, during the first part of a cycle and delivering this energy to a capacitor C in the remaining part of the cycle. The energy stored in the capacitor will in turn be delivered to the load. The process for transferring the energy to the load is realized using an active switch (MOSFET transistor) and a passive switch (diode). In these converters, the DC conversion ratio is a function of the duty ratio of the active switch. For a description of the operation and various applications of DC-DC converters reference is made to R. W. Erickson and D. Maksimovic, Fundamentals of Power Electronics, Second Edition, Kluwer Academic Publishers, 2001 and the numerous references therein. The development of new technologies is requiring wider conversion ratios; for example, new integrated circuits are using 3.3 V or 1.5 V power supplies. The above requirements can be satisfied using a conventional PWM converter by: (a) operating at extremely low duty ratio U, with the corresponding limitations on the finite commutation times of the switching devices; or (b) using a step-down transformer with the corresponding difficulties in switching surges and operating frequencies.

In theory, wider conversion ratios can be obtained by properly adjusting the duty ratio of the switching signal applied to the active switch. In practice, the maximum and the minimum attainable conversion ratios for the conventional converters are limited by the characteristics of the switching devices. The turn-on time and turn-off time of the active switch now play an important role for the attainable duty ratio and, consequently, in the conversion ratio. Also, when the duty ratio is close to 0 or 1, a great deterioration on the output voltage and inductor current signals occur and; therefore, in the control signal. For the above reasons, it is better to select an operating point in the midrange, i.e., U=0.5. On the other hand, an often used approach is to use a step-down transformer; however, large switching surges are present that may damage the switching devices and make the controller difficult to design. Also, the transformer itself would limit the switching frequency of the converter.

A scheme that provides wider conversion ratios is the cascade connection of converters. This scheme is a multistage approach that consists of two or more converters connected in cascade. One of the major advantages of these converters is a high gain; however, a major drawback is that the total efficiency may be low if the number of stages is high. One of the main disadvantages of the cascade connection is that the total efficiency is reduced mainly by losses in the switching devices. For a description of n-buck converters connected in cascade with n-active switches a reference is made to J. A. Morales-Saldaña, J. Leyva-Ramos and E. E. Carbajal-Gutierrez, “Modeling of Switch-Mode DC-DC Cascade Converters,” IEEE Trans. Aerosp. Electron. Syst., Vol. 38. No. 1, pp. 295-299, 2002, the contents of which are incorporated herein by reference. If a quadratic ratio is required, it is much better to use quadratic converters, which use only one active switch. From the efficiency viewpoint, a converter with a single switch is better than a converter with two switches.

Early work to obtain wider conversion ratios has been proposed by the cascade connection of buck and buck-boost converters to obtain low-voltage in power supplies. For a description of a cascade connection a reference is made to H. Matsuo and K. Harada, “The Cascade Connection of Switching Regulators,” IEEE Trans. Ind. Appl., Vol. 12, No. 2, pp. 192-198, 1976, the contents of which are incorporated herein by reference. Six configurations using a single transistor with quadratic DC conversion ratio have been developed. For a description of single-transistor PWM converters featuring voltage conversion ratios with a quadratic dependence on the duty ratio a reference is made to D. Maksimovic and S. Cuk, “Switching Converters With Wide DC Conversion Range,” IEEE Trans. Power Electron., Vol. 6, No. 1, pp. 151-157, January 1991, the contents of which are incorporated herein by reference. The use of a cascaded buck converter to provide a low output voltage is disclosed in U.S. Pat. No. 5,886,508. In this patent, a cascaded buck converter comprises a main buck that is coupled to a subordinate buck converter through a cascade transistor in series with the free wheeling diode or transistor. The main buck converter is coupled to the free wheeling diode through the cascade transistor.

### SUMMARY OF THE INVENTION

In this patent, a topology for an n-buck cascade converter with a single active switch is proposed which will allow the production of a lower voltage/higher current output. The cascade configuration allows a DC conversion ratio of Uⁿ where U is the duty ratio, using a minimum number of active switches while avoiding a complex control circuitry. This converter is comprised of n inductors, n capacitors, (2n-1) diodes and a single MOSFET transistor. It is assumed that this converter operates in continuous condition mode, i.e., all the inductor currents never decay to zero. The corresponding formulae for the ripples in the capacitor voltages and the inductor currents are given which would allow in principle to design a specific converter following some specifications.

In one aspect, the present invention provides an n-buck cascade converter with a single active switch as described herein. This converter comprises n inductors, n capacitors, (2n-1) diodes and a single MOSFET transistor. This converter is useful for providing a lower voltage/higher current output. In this converter, the DC conversion ratio is V₀/E=Uⁿ where U is the duty ratio of the switching signal applied to the MOSFET transistor. The use of the above converter avoids using a conventional PWM converter by: (a) operating at extremely low duty ratio U with the corresponding limitations on the finite commutation times of the switching devices; or (b) using a step-down transformer with the corresponding difficulties in switching surges and operating frequencies.

Conditions in the inductors are given to assure that the converter will operate in continuous conduction mode. Also, formulae for the ripples in the capacitor voltages and the inductor currents are given. The above formulae are useful because a cascade converter can be designed following some specifications. Typically in a conventional converter the ripples in the capacitor voltages should lie in the range of 1% to 2%. Also, it has been suggested by the power supply industry that the ripples in the inductor currents should lie in the range of 10% to 20%.

Other forms, features, and aspects of the above cascade converter are described in the detailed description that follows.

### BRIEF DESCRIPTION OF THE DRAWINGS

These and other features of the invention will become more apparent in the following detailed description in which reference is made to the appended drawings wherein:

FIG. 1 shows a block diagram of the n-buck cascade converter with a MOSFET transistor as an active switch;

FIG. 2 shows a block diagram of the n-buck cascade converter when the MOSFET transistor is on;

FIG. 3 shows a block diagram of the n-buck cascade converter when the MOSFET transistor is off;

FIG. 4 shows a theoretical plot for the capacitor voltages showing a detail description of the ripple. (y-axis V, x-axis s); and,

FIG. 5 shows a theoretical plot for the inductor currents showing a detail description of the ripple. (y-axis A, x-axis s).

### DETAILED DESCRIPTION OF THE INVENTION

A scheme that provides a wider conversion ratio without a transformer is a cascade converter. This scheme consists of n-conventional converters connected in cascade with n-active switches. The conversion rate, for duty ratios Uᵢ, is

$${\prod }_{i = 1}^{n} {U}_{i} .$$

A second scheme consists of an n-buck cascade converter with a single active switch. The conversion rate, for a duty ratio U is Uⁿ. An advantage of the last scheme is that the total efficiency is much better because of the use of a single switch.

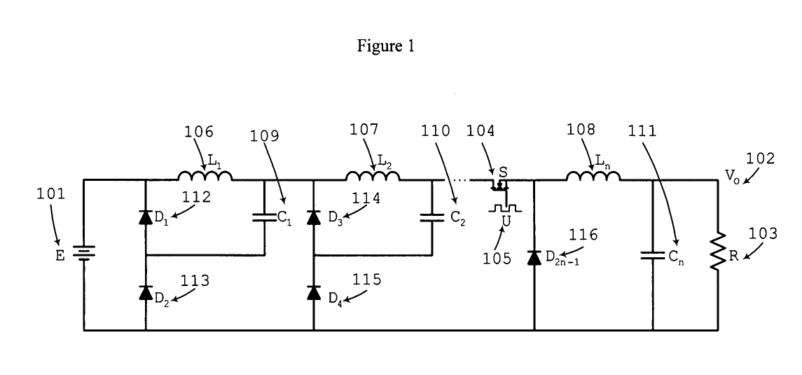

The block diagram of the n-buck cascade converter is shown in FIG. 1 where E is the input voltage from an unregulated power source 101, Vₒ is the output voltage 102 and R is the load 103. The MOSFET transistor 104 is operated using a switching signal with a duty ratio U 105. This converter requires n inductors L₁, L₂, . . . , Lₙ 106, 107, 108 all connected is series, n capacitors C₁, C₂, . . . , Cₙ 109, 110, 111 all connected in parallel and (2n-1) diodes 112, 113, 114, 115, 116. This converter is operated at a constant switching frequency ƒₛ which results in a switching period of T=1/ƒₛ. It is assumed herein that this converter operates in continuous conduction mode (CCM), i.e., all the inductor currents never decay to zero.

The conversion ratio for the n-buck cascade converter is derived using averaging techniques. The resulting DC conversion rate is Vo/E=Uⁿ where n is the number of stages connected in series and U represents, throughout this patent, the duty ratio. U is the duty ratio of the switching signal acting over the MOSFET Transistor.

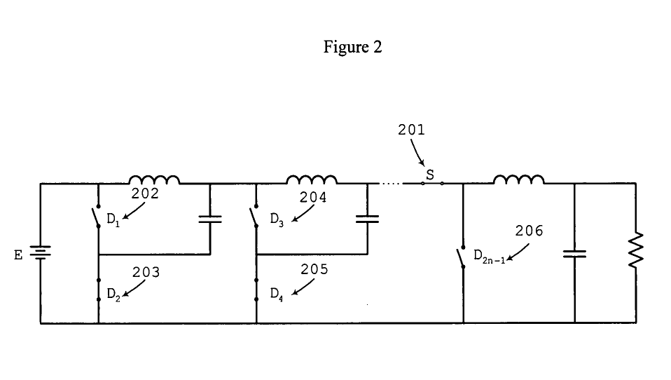

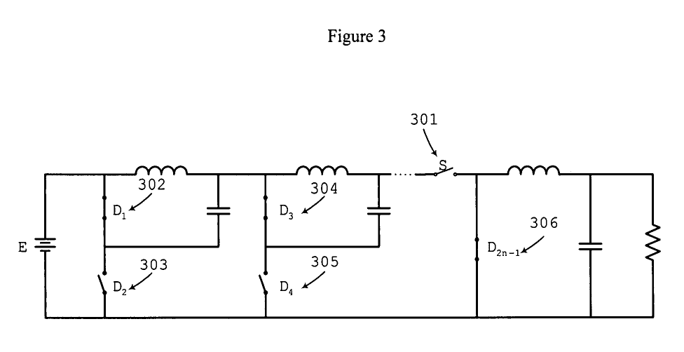

In this converter, when the MOSFET transistor is turned on, it results in the operation given in FIG. 2. In this operating condition, diodes D₂, D₄ (203, 205) will turn on simultaneously and will provide paths for the currents of the inductors. During the MOSFET transistor on-time, diodes D₁, D₃, D₂ₙ₋₁ (202, 204, 206) are off. When the transistor MOSFET is turned off, it results in the operation given in FIG. 3. In this operating condition, diodes D₂, D₄, . . . , D₂ₙ₋₂ (303, 305) will be off simultaneously. During this MOSFET transistor off-time, diodes D₁, D₃, . . . , D₂ₙ₋₁ (302, 304, 306) are on and will provide paths for the currents of the inductors. Since the n-switched networks in FIG. 1 are electrically identical to n-stages connected in cascade, the n-buck cascade converter has a DC conversion ratio given by Vₒ/E=Uⁿ.

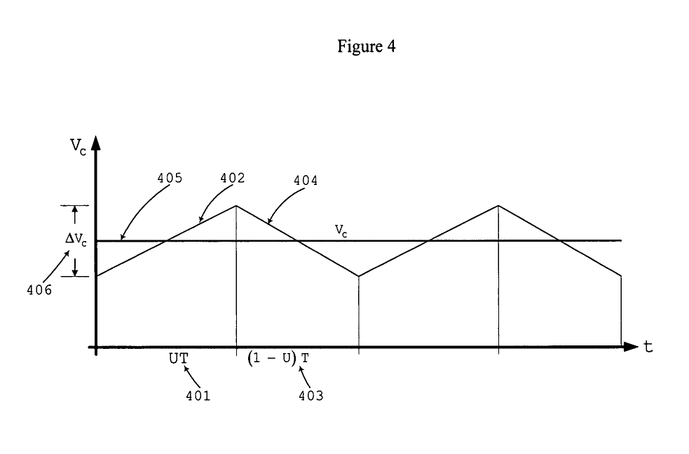

When the switching frequency fₛ is fast enough with respect the time constants of each network, the capacitor voltages, V_{c}, will have the form given in FIG. 4 where, in the period UT (401) the capacitors are charged (402) and in the period (1-U)T (403) the capacitors are discharged (404). Thus, the capacitor voltages, V_{c}, will have average values (405) given by V_{Ci}=EUⁱ for i=1, . . . , n. It is clear that the voltage values will reduce along the cascade converter due to 0<U <1. The ripples in the capacitor voltages can be easily calculated. The resulting ripples can be computed using the following formula:

$$Δ {V}_{Ci} = \frac{{U}^{2 n - i} E ( 1 - U )}{{Rf}_{s} {C}_{i}} for i = 1 , … , n - 1$$

where V_{C} is the capacitor voltage, E is the input voltage, U is the duty ratio, R is a load, fₛ is the switching frequency and Cᵢ is the capacitance of an element under study.

Due to the structure of this cascade converter, the ripple in output capacitor is given by:

$$Δ {V}_{Cn} = \frac{{U}^{n} E ( 1 - U )}{8 {f}_{s}^{2} {L}_{n} {C}_{n}}$$

where V_{C} is the capacitor voltage, E is the input voltage, U is the duty ratio, fₛ is the switching frequency, Lₙ is the inductance of an element n and Cₙ is the capacitance of the element n.

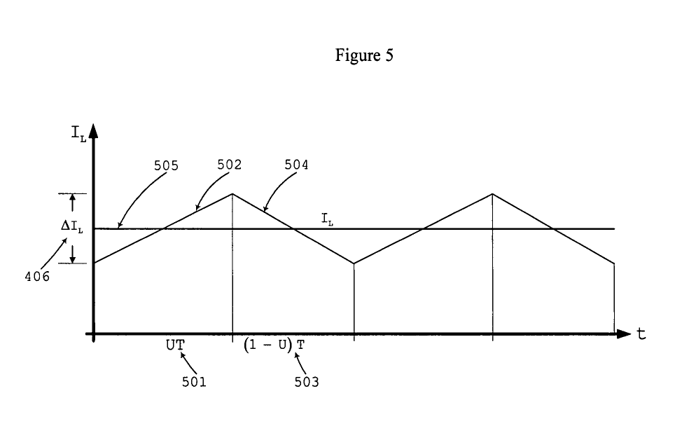

Following the same analysis as before, the inductor currents, I_{L}, of each stage will have the form given in FIG. 5 where, in the period UT (501), the inductors are charged (502) and, in the period (1-U)T (503), the inductors are discharged (504). Thus, the inductor currents, I_{L}, will have average values (505) given by I_{Li}=IₒUⁿ⁻ⁱ for i=1, . . . , n where Iₒ is the output current. It is clear that the inductor currents will increase along the cascade converter due to 0<U<1 having the output current the greatest value. For continuous conduction mode, the inductors meet the following condition:

$${L}_{i} > \frac{( 1 - U ) R}{2 {f}_{s} {U}^{2 ( n - i )}} for i = 1 , … , n$$

where Li is the inductance of an element under study, U is the duty ratio, R is the output load and fₛ is the switching frequency.

The ripples 506 in the inductor currents can be easily calculated by considering the voltages that appear in the inductors. The resulting ripples can be computed using the following formulae:

$$Δ {I}_{Li} = \frac{EU ( 1 - U )}{{L}_{i} {f}_{s}} for i = 1 , … , n$$

where IL is the inductor current, E is the input voltage, U is the duty ratio, Li the inductance of an element under study and fs is the switching frequency.

The above formulae are useful because a cascade converter can be designed following some specifications. Typically in a conventional converter, the ripple ratio in the capacitor voltage εᵥ=(Δv_{C}/2)/V_{C} should lie in the range of 1% to 2%. Also, the power supply industry has suggested using a ripple ratio in the inductor current εᵢ=(Δi_{L}/2)/I_{L} in the range of 10% to 20%.

Although the invention has been described with reference to certain specific embodiments, various modifications thereof will be apparent to those skilled in the art without departing from the purpose and scope of the invention as outlined in the claims appended hereto. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way. The disclosures of all prior art recited herein are incorporated herein by reference in their entirety.

What we claim is:

1. An n-buck cascade converter comprising:
n inductors L₁, L₂, . . . , Lₙ;
n capacitors C₁, C₂, . . . , Cₙ;
(2n-1) diodes D₁, D₂, . . . , D₂ₙ₋₁; and,
a single MOSFET transistor S operating as an active switch, where the converter is operated at a constant switching frequency, said inductors, capacitors, diodes and transistor arranged in a circuit as shown below: 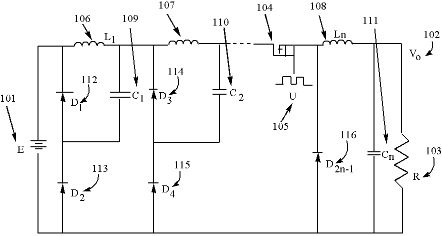
where E is the input voltage and R is a load.

2. The cascade converter as claimed in claim 1 where the converter is operatively arranged to operate in continuous conduction mode providing a DC conversion ratio of Vₒ/E=Uⁿ wherein U represents a duty ratio U, Vₒ is the output voltage and E is the input voltage.

3. The cascade converter as claimed in claim 1 wherein, when the MOSFET transistor is on, diodes D₂, D₄, . . . , D₂ₙ₋₂ will be on and diodes D₁, D₃, . . . D₂ₙ₋₁ will be off shown below:

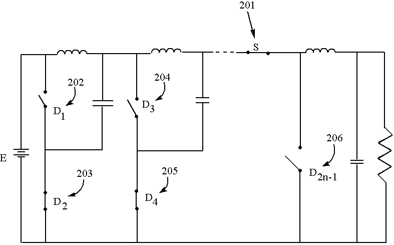

4. The cascade converter as claimed in claim 1 wherein, when the MOSFET transistor is off, diodes D₁, D₃, . . . , D₂ₙ₋₁ will be on and diodes D₂, D₄, . . . , D₂ₙ₋₂ will be off as shown below:

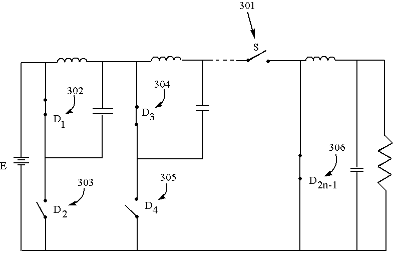

5. The cascade converter as claimed in claim 1, wherein the average values for the capacitor voltages of each stage is represented by the equation:
V_{Ci}=EUⁱ for i=1, . . . , n
where E is the input voltage and U is the duty ratio.

6. The cascade converter as claimed in claim 1, wherein the average values for inductor currents of each stage is represented by the equation:
I_{Li}=IₒUⁱ⁻¹ for i=1, . . . , n
where Li is the inductance of an element under study, Iₒ is the output current and U is the duty ratio.

7. The cascade converter as claimed in claim 1, wherein for continuous conduction mode the inductors meet the following condition:
$${L}_{i} > \frac{( 1 - U ) R}{2 {f}_{s} {U}^{2 ( n - i )}} for i = 1 , … , n$$
where Li is the inductance of an element under study, U is the duty ratio, R is the output load and fₛ is the switching frequency.

8. The cascade converter as claimed in claim 1, wherein ripples in capacitor voltages is represented by the equation:
$$Δ {V}_{Ci} = \frac{{U}^{2 n - i} E ( 1 - U )}{{Rf}_{s} {C}_{i}} for i = 1 , … , n - 1$$
where V_{C} is the capacitor voltage, E is the input voltage, U is the duty ratio, R is a load, fₛ is the switching frequency and Cᵢ is the capacitance of an element under study.

9. The cascade converter as claimed in claim 1 wherein, a ripple in capacitor voltage for a capacitor Cₙ is represented by the equation:
$$Δ {V}_{Cn} = \frac{{U}^{n} E ( 1 - U )}{8 {f}_{s}^{2} {L}_{n} {C}_{n}}$$
where V_{C} is the capacitor voltage, E is the input voltage, U is the duty ratio, fₛ is the switching frequency, Lₙ is the inductance of an element n and Cₙ is the capacitance of the element n.

10. The cascade converter as claimed in claim 1, wherein ripples in the inductor currents are represented by the equation:
$$Δ {I}_{{L}_{i}} = \frac{EU ( 1 - U )}{{L}_{i} {f}_{s}} for i = 1 , … , n$$
where I_{L} is the inductor current, E is the input voltage, U is the duty ratio, Lᵢ the inductance of an element under study and fₛ is the switching frequency.
